(19) United States
(12) Patent Application Publication
(10) Pub. No.: US 2003/0184750 A1
(43) Pub. Date: Oct. 2, 2003

(54) Ellipsometer or reflectometer with elliptical aperture

(76) Inventors: David M. Aikens, Pleasanton, CA (US); Jay J. Chen, Fremont, CA (US); Lanhua Wei, Fremont, CA (US)

Correspondence Address: STALLMAN & POLLOCK LLP, Suite 290, 121 Spear Street, San Francisco, CA, 94105, US

(21) Appl. No.: 10/253,037

(22) Filed: Sep. 24, 2002

Related U.S. Application Data
(60) Provisional application No. 60/369,400, filed on Apr. 2, 2002.

(51) Int. Cl. G01J 4/00

(52) U.S. Cl. 356/369

(57) ABSTRACT

An ellipsometer or reflectometer includes a light source creating a mono or polychromatic probe beam. The probe beam is focused by one or more lenses to create an illumination spot on the surface of the subject under test. A second lens (or lenses) images the illumination spot (or a portion of the illumination spot) to a detector. The detector captures (or otherwise processes) the received image. A processor analyzes the data collected by the detector. An aperture is positioned along the beam bath between the light source and the detector. The aperture has an elliptical shape to give the image received by the detector a circular shape. The circular shape maximizes the amount of energy that may be received using a square test area.

### PRIORITY CLAIM

The present application claims priority to U.S. Provisional Patent Application Serial No. 60/369,400, filed Apr. 2, 2002, which is incorporated herein by reference.

### TECHNICAL FIELD

This subject invention relates to an ellipsometer or reflectometer that uses an elliptical aperture to maximize the amount of reflected light that is available for analysis during measurements made at non-normal angles of incidence.

### BACKGROUND OF THE INVENTION

As geometries continue to shrink, manufacturers have increasingly turned to optical techniques to perform non-destructive inspection and analysis of semi-conductor wafers. The basis for these techniques is the notion that a subject may be examined by analyzing the reflected energy that results when a probe beam is directed at the subject. Ellipsometry and reflectometry are two examples of commonly used optical techniques. For the specific case of ellipsometry, changes in the polarization state of the probe beam are analyzed. Reflectometry is similar, except that changes in magnitude are analyzed. Ellipsometry and reflectometry are effective methods for measuring a wide range of attributes including information about thickness, crystallinity, composition and refractive index. The structural details of ellipsometers are more fully described in U.S. Pat. Nos. 5,910,842 and 5,798,837 both of which are incorporated in this document by reference.

As shown in FIG. 1, a typical ellipsometer or reflectometer includes an illumination source that creates a mono or polychromatic probe beam. The probe beam is focused by one or more lenses to create an illumination spot on the surface of the subject under test. A second lens (or lenses) and an aperture image the illumination spot (or a portion of the illumination spot) to a detector. The detector captures (or otherwise processes) the received image. The portion of the illumination spot that is captured by the detector is generally a two-dimensional square or rectangle and is generically referred to as the test region. The dimensions of the test region correspond, in many cases, to the pixel grid of a CCD (charge coupled device) or other photo-sensitive array that performs the actual image capture. A processor analyzes the data collected by the detector.

Effectively imaging the illumination spot into the test area is an important part of optimizing detector efficiency. The basic goal is to maximize the amount of light the test area receives from the illumination spot. This is a crucial consideration for semiconductor applications where small illumination spots must be used. At the same time, it is critical to minimize the amount of noise that reaches the detector. Noise, or stray light, may be defined as: a) light that has taken a more circuitous path to the detector, such as by scattering off of the surface or edge of a component, b) light that has followed the correct path, but has reflected from the subject at a location slightly displaced with respect to the location under test, or c) light that has reflected from the subject at the correct location but at an angle that is undesirable.

The aperture (see FIG. 1) is used to limit the amount of noise reaching the detector. Typically, the aperture is formed as a slit in a thin piece of metal, such as stainless steel. The slit aperture provides an effective mechanism for limiting noise on either side of the slit. At the same time, the slit provides no noise control for noise entering along the slit but outside of the path normally associated with the illumination spot. For this reason, systems that use slit apertures must carefully control the size of the illumination spot to prevent unwanted noise from reaching the detector.

For these reasons, a pinhole aperture is sometimes used in place of the slit aperture. The pinhole aperture is better at controlling noise in all directions. Unfortunately, use of a pinhole aperture also means that the resulting image is shaped as an ellipse. The major radius of the elliptical image is equal to the minor radius multiplied by 1/cos(θ) where θ is the angle of incidence (the angle between the subject's surface normal Z and the incoming probe beam). This relationship means that the image becomes increasingly elliptical as the angle of incidence increases. Projecting this image into the square or rectangular test area necessarily wastes some portion of the test area. This is illustrated, for example, in FIG. 2 where an elliptical image is shown projected into a square test area. The test area has a total area equal to a². The image has an area equal to a²π cos(θ)/4. The efficiency of the test area, defined as the area of the image divided by the area of the test area is then: π cos(θ)/4. At an incident angle of 65 degrees (roughly what is shown in FIGS. 1 and 2) the efficiency of the test area is less than thirty-three percent. At best (when the incident angle is zero) the efficiency of the test area is less than seventy-nine percent. The overall result is that use of a pinhole aperture controls noise, but also reduces the detector efficiency.

For these reasons, a need exists for better methods for eliminating noise from the beam path within ellipsometers and reflectometers. This need is particularly relevant for semiconductor applications where shrinking geometries require the of smaller and smaller illumination spots.

### SUMMARY OF THE INVENTION

The present invention provides an ellipsometer or reflectometer for use with small illumination spot sizes at non-normal angle of incidence. The ellipsometer or reflectometer includes an illumination source that creates a mono or polychromatic probe beam. The probe beam is focused by one or more lenses to create an illumination spot on the surface of the subject under test. A second lens (or lenses) images the illumination spot (or a portion of the illumination spot) to a detector. The detector captures (or otherwise processes) the received image. A processor analyzes the data collected by the detector.

An aperture is positioned along the beam bath between the light source and the detector. The aperture has an elliptical shape with an aspect ratio (i.e., major dimension divided by minor dimension) equal to the 1/cos(θ_{pref}) where θ_{pref} is a preferred angle of incidence angle to be employed during analysis. The aperture is rotated so that its major radius is perpendicular to the surface normal of the subject (the Z-axis). The overall effect of the aperture is to give the image received by the detector a circular shape when the angle of incidence is equal to θ_{pref}. The circular shape maximizes the amount of energy that may be received using a square test area. Suitable modifications to the shape of the aperture may be used where rectangular test areas are used. Maximizing the energy received by the detector enables the ellipsometer or reflectometer to be used with small illumination spot sizes and high angles of incidence.

### BRIEF DESCRIPTION OF THE DRAWINGS

FIG. 1 is a diagram of ellipsometer or reflectometer shown to describe prior art for the present invention.

FIG. 2 is an image created by a prior art ellipsometer or reflectometer shown.

FIG. 3 is a diagram of ellipsometer or reflectometer according to an embodiment of the present invention.

FIG. 4 is a diagram of a variable pinhole aperture according to an embodiment of the present invention.

FIG. 5 is a diagram of an aperture wheel according to an embodiment of the present invention.

FIG. 6 is a diagram of ellipsometer or reflectometer using the aperture wheel of FIG. 5.

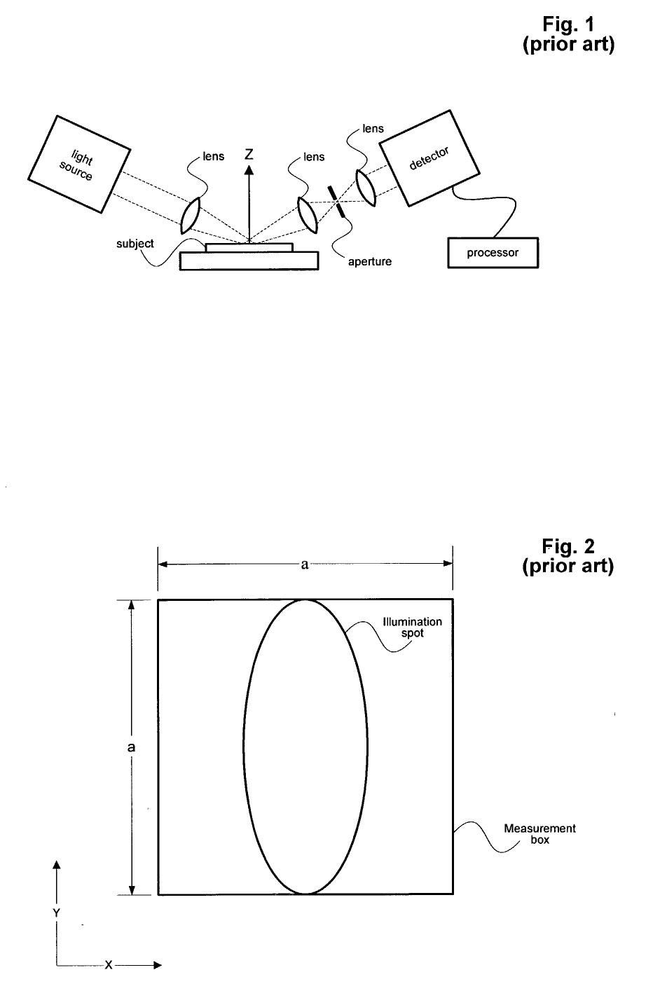

### DETAILED DESCRIPTION OF THE PREFERRED EMBODIMENTS

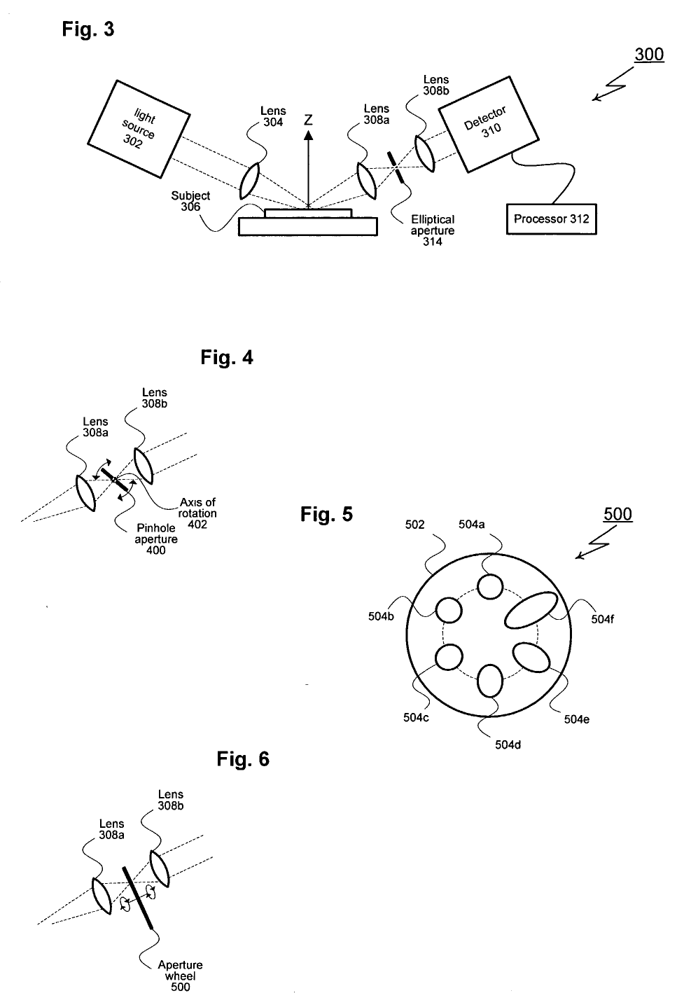

The present invention provides an ellipsometer or reflectometer for use with small illumination spot sizes at non-normal angles of incidence. A representative implementation for the ellipsometer or reflectometer is generally designated 300 in FIG. 3. Ellipsometer or reflectometer 300 includes an illumination source 302 that creates a mono or polychromatic probe beam. The probe beam is focused by one or more lenses 304 to create an illumination spot on the surface of the subject 306 under test.

A second lens 308 (or lenses) images the illumination spot (or a portion of the illumination spot) to a detector 310. The detector 310 captures (or otherwise processes) the received image. A processor 312 analyzes the data collected by the detector 310. The detector 310 receives the projected image in a two-dimensional test area. The test area is typically square or rectangular and, in many cases, corresponds to the surface of a CCD (charge coupled device) or other photo-sensitive array that performs the actual image capture.

An elliptical aperture 314 is positioned along the beam bath between the illumination source 302 and the detector 310. The aperture 314 is formed as an elliptically shaped opening in a thin plate or surface. The aperture 314 has an aspect ratio (i.e., major radius divided by minor radius) equal to the 1/cos(θ_{pref}) where θ_{pref} is a preferred angle of incidence angle to be employed during analysis. The aperture is rotated so that its major radius is perpendicular to the surface normal of the subject (the Z-axis). The overall effect of the aperture is to give the image received by the detector 310 a circular shape when the angle of incidence θ is equal to θ_{pref}. The circular shape maximizes the amount of energy that may be received using a square test area.

The efficiency of ellipsometer or reflectometer 300 is maximized when the angle of incidence θ matches the preferred angle of incidence θ_{pref}. As a result, it is generally desirable to choose the preferred angle of incidence θ_{pref} to match the angle of incidence most used during operation of ellipsometer or reflectometer 300. In some cases, selection of a single angle as the preferred angle of incidence θ_{pref} is undesirable. In such cases, it is possible to replace the aperture 314 with a pinhole aperture 400 as shown in FIG. 4. Pinhole aperture 400 is formed as a circular hole in a thin plate or surface and may be rotated around an axis of rotation 402. The axis of rotation 402 is aligned with the center of the pinhole aperture 400 and the center of the reflected probe beam passing through the pinhole aperture 400. Rotation around the axis of rotation 402 makes the pinhole aperture 400 effectively elliptical. Preferably, the degree of rotation starts with the pinhole aperture 400 aligned to present a circular aperture when the angle of incidence θ is zero. For this alignment, the plate that is used to form the pinhole aperture 400 is perpendicular to the path traveled by the reflected probe beam. The degree of rotation of the pinhole aperture 400 is then increased in proportion to any increase in the angle of incidence θ. Quantitatively, the angle of rotation is equal to Mθ where M is the angular magnification of the optical path. Rotation of the pinhole aperture 400 in direct proportion to the angle of incidence θ assumes that the pinhole aperture 400 is made from extremely thin material (and becomes ideal when the material has zero thickness). In real world cases, the degree of rotation may be subtly modified to reflect the actual thickness of the material used to construct the pinhole aperture 400.

In FIG. 5, an aperture wheel is shown and generally designated 500. Aperture wheel 500 is formed as a thin, flat disk 502 using an opaque material such as stainless steel. Disk 502 includes a series of apertures 504, in a radial distribution. Each aperture 504 is formed to have an aspect ratio equal to the 1/cos(θ_{pref}) for a particular preferred incident angle θ_{pref}. In the specific examples, apertures 504 are formed for the preferred incident angles 0, 13, 26, 39, 52 and 65. As shown in FIG. 6, aperture wheel 500 is positioned so that the reflected probe beam passes through a selected aperture 504. As the angle of incidence θ changes, aperture wheel 500 may be rotated to select a matching aperture 504.

The preceding description has focused on the use of elliptical apertures to produce circular images. In some cases, it is useful to modify the elliptical aperture to generate images having different shapes. This is the case where a rectangular test area is used. Subtle modifications to the elliptical shape can be used to ovalize the projected image to more efficiently fill the rectangular test area. In some cases, the elliptical shape may be replaced with a rectangular aperture. In such cases, the aspect ratio (major dimension divided by minor dimension) 1/cos(θ_{pref}) is retained from the elliptical case. The orientation of the rectangular aperture is similarly unchanged with the major dimension oriented to be perpendicular to the surface normal of the subject. The use of a rectangular aperture produces a rectangular image. This is useful in cases where the projected image may be accurately aligned with the test area. The use of a variable square aperture (analogous to the pinhole aperture of FIG. 4) or an aperture wheel of rectangular apertures are both practical.

In FIGS. 3, 4 and 6, the aperture is shown to be positioned downstream of the subject 306 and just upstream of the detector 310. It should be appreciated that this particular position is representative. Each of the described apertures may be positioned anywhere between illumination source 302 and the detector 310.

What is claimed is:

1. An ellipsometer or reflectometer that comprises:
a light source to create an illumination spot on the surface of a subject under test;
one or more lenses to create a projected image of the illumination spot on a test area; and
an aperture positioned between the light source and the test area to give the projected image a circular shape.

2. An ellipsometer or reflectometer as recited in claim 1, wherein the aperture has an elliptical shape with an aspect ration equal to 1/cos(θ_{pref}) where θ_{pref} is a preferred angle of incidence.

3. An ellipsometer or reflectometer as recited in claim 1, wherein the aperture has a circular shape and is inclined with respect to the test area to give the projected image a circular shape.

4. An ellipsometer or reflectometer as recited in claim 3, wherein the angle of inclination of the aperture is equal to M times angle of incidence where M is the angular magnification of the optical path.

5. An ellipsometer or reflectometer as recited in claim 1, wherein the aperture is part of a selectable series of apertures, each matching a respective angle of incidence.

6. An ellipsometer or reflectometer that comprises:
a light source to create an illumination spot on the surface of a subject under test;
one or more lenses to create a projected image of the illumination spot on a test area; and
an aperture positioned between the light source and the test area to give the projected image a square shape.

7. An ellipsometer or reflectometer as recited in claim 6, wherein the aperture has a rectangular shape with an aspect ration equal to 1/cos (θ_{pref}) where θ_{pref} is a preferred angle of incidence.

8. An ellipsometer or reflectometer as recited in claim 6, wherein the aperture has a square shape and is inclined with respect to the test area to give the projected image a circular shape.

9. An ellipsometer or reflectometer as recited in claim 8, wherein the angle of inclination of the aperture is equal to M times angle of incidence where M is the angular magnification of the optical path.

10. An ellipsometer or reflectometer as recited in claim 6, wherein the aperture is part of a selectable series of apertures, each matching a respective angle of incidence.

11. A device for optically inspecting and evaluating a subject, the device comprising:
(a) a light source to create an illumination spot on the surface of a subject under test;
(b) one or more lenses to create a projected image of the illumination spot on a test area;
(c) an aperture positioned between the light source and the test area to give the projected image a circular shape;
(b) a detector for measuring image within the test area; and
(f) a processor for analyzing the measurements made by the detector.

12. A device as recited in claim 11, wherein the aperture has an elliptical shape with an aspect ration equal to 1/cos(θ_{pref}) where θ_{pref} is a preferred angle of incidence.

13. A device as recited in claim 11, wherein the aperture has a circular shape and is inclined with respect to the test area to give the projected image a circular shape.

14. A device as recited in claim 13, wherein the angle of inclination of the aperture is equal to M times angle of incidence where M is the angular magnification of the optical path.

15. A device as recited in claim 11, wherein the aperture is part of a selectable series of apertures, each matching a respective angle of incidence.
